(19) United States
(12) Patent Application Publication
(10) Pub. No.: US 2014/0139032 A1
(43) Pub. Date: May 22, 2014

(54) MODIFIED PERTURN AND OBSERVE OF TRANSCONDUCTANCE TRANSFER FOR MAXIMUM POWER POINT TRACKING IN PHOTOVOLTAIC SYSTEMS

(71) Applicant: SunEdison LLC, Beltsville, MD (US)

(72) Inventors: Jayaraman Vijay Shankar, San Jose, CA (US); Suryanarayana Potharaju, San Jose, CA (US)

(21) Appl. No.: 14/086,646

(22) Filed: Nov. 21, 2013

Related U.S. Application Data
(60) Provisional application No. 61/729,286, filed on Nov. 21, 2012.

(51) Int. Cl. G05F 5/00

(52) U.S. Cl. CPC G05F 5/00
USPC 307/82

(57) ABSTRACT

In one example, a method of operating a photovoltaic (PV) system substantially at a maximum power point is described. The PV system includes a PV module and an inverter coupled to the PV module. The method includes controlling an output of the inverter as a function of a trans-conductance of the PV module over time.

### CROSS REFERENCE TO RELATED APPLICATIONS

This application claims priority to U.S. Provisional Patent Application Ser. No. 61/729,286, filed Nov. 21, 2012, which is hereby incorporated by reference in its entirety.

### FIELD

The field of the disclosure relates generally to photovoltaic (PV) systems. More particularly, this disclosure relates to methods and systems for maximum power point tracking in PV systems.

### BACKGROUND

Photovoltaic (PV) modules (also known as solar modules) convert solar energy into electrical energy. The electrical energy may be used directly at the site, converted for local use, and/or converted and transmitted to an electrical grid or another destination. Typically, a PV installation includes at least a plurality of PV modules logically or physically grouped together to form an array and one or more inverters that convert the direct current (DC) output of the PV modules to alternating current (ΔC) power.

A number of techniques exist for determining and tracking the maximum power point (MPP) of PV modules in PV power generation systems. Some known systems utilize a perturb and observe method of maximum power point tracking (MPPT). In this method, the PV modules output voltage or current is periodically varied. If the power output of the module increases when voltage Or current is varied, the voltage/current is next perturbed in the same direction. When the perturbation causes a decrease in output power, the direction of voltage/current change is reversed for the next perturbation. This method is a simple search algorithm which perturbs the panel voltage or current to converge on the MPP of the PV panel with a probability of convergence of about 99.6% and a maximum of 20-30 perturbations per hour. The perturb and observe method is relatively slow and cannot differentiate fast overcast conditions on the panel.

Some other known systems use an incremental conductance methods of MPPT. Incremental conductance methods use incremental changes in module current and voltage to predict the effect of a voltage change to track the MPP. In such methods, the conductance of the PV module is maintained at such a level that the MPP is reached with a probability of 100%. Incremental conductance methods are generally fast, but require more computational power than perturb and observe methods and are prone to oscillations and spinlocks.

This Background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a method of operating a photovoltaic (PV) system substantially at a maximum power point is described. The PV system including a PV module and an inverter coupled to the PV module. The method includes determining, by the inverter, a change in a voltage output of the PV module from a first time to a second time, determining, by the inverter, a change in a current output of the PV module from the first time to the second time, determining, by the inverter, a change in a power output of the PV module based, at least in part, on the determined change in current output and change in voltage output, determining, by the inverter, a change in a trans-conductance of the PV module from the first time to the second time, and setting, by the inverter, a power output setpoint for the inverter as a function of the determined change in trans-conductance and the determined change in power output.

In another aspect, a method of operating a photovoltaic (PV) system substantially at a maximum power point is described. The PV system includes a PV module and an inverter coupled to the PV module. The method includes controlling an output of the inverter as a function of a trans-conductance of the PV module over time.

Yet another aspect is a computing device for use in a photovoltaic (PV) system including a PV module and an inverter. The computing device includes a processor and a memory coupled to the processor. The memory includes computer-executable instructions that, when executed by the processor, cause the computing device to: determine a change in a voltage output of the PV module from a first time to a second time, determine a change in a current output of the PV module from the first time to the second time, determine a change in a power output of the PV module based, at least in part, on the determined change in current output and change in voltage output, determine a change in a trans-conductance of the PV module from the first time to the second time, and set a power output setpoint for the inverter as a function of the determined change in trans-conductance and the determined change in power output.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of an example photovoltaic (PV) module;

FIG. 2 is a cross-sectional view of the PV module shown in FIG. 1 taken along the line A-A; PATENT

FIG. 3 is a block diagram of an example computing device;

FIG. 4 is a block diagram of an example PV system;

FIG. 5 is a graph of output power and voltage of a PV module as a function of output current; flow diagram of an example method of monitoring a PV system; and

FIG. 6 is a flow diagram of an example method of operating a PV system at substantially a maximum power point.

Like reference symbols in the various drawings indicate like elements.

### DETAILED DESCRIPTION

The embodiments described herein generally relate to photovoltaic (PV) systems. More particularly, the embodiments described herein relate to methods and systems for maximum power point tracking (MPPT) in PV systems. Exemplary systems and methods incorporate the MPPT by perturbing and observing the trans-conductance of a PV module for substantially oscillation free maximal convergence.

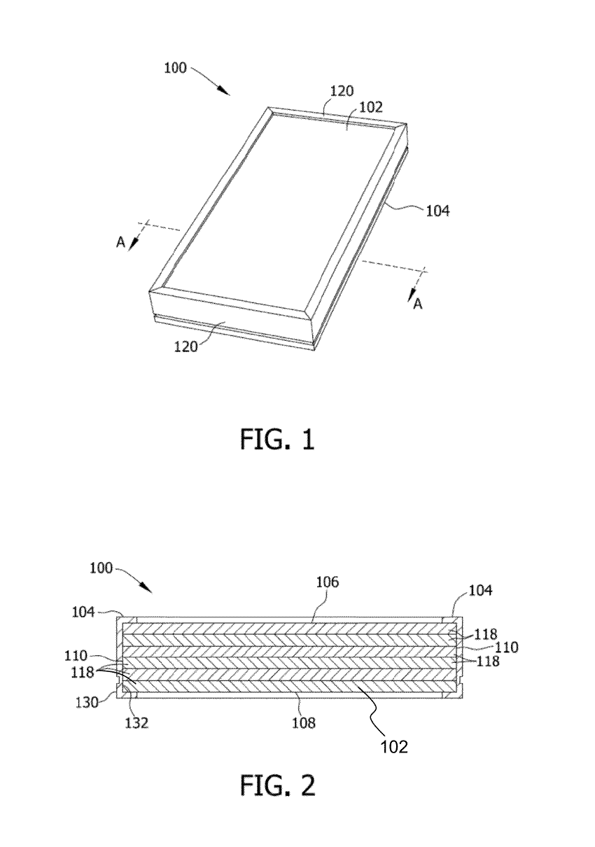

Referring initially to FIGS. 1 and 2, a PV module is indicated generally at 100. A perspective view of the PV module 100 is shown in FIG. 1. FIG. 2 is a cross sectional view of the PV module 100 taken at line A-A shown in FIG. 1. The PV module 100 includes a solar laminate 102 (also referred to as a PV laminate) and a frame 104 circumscribing the solar laminate 102.

The solar laminate 102 includes a top surface 106 and a bottom surface 108 (shown in FIG. 2). Edges 110 extend between the top surface 106 and the bottom surface 108. In this embodiment, the solar laminate 102 is rectangular shaped. In other embodiments, the solar laminate 102 may have any suitable shape.

As shown in FIG. 2, the solar laminate 102 has a laminate structure that includes several layers 118. Layers 118 may include for example glass layers, non-reflective layers, electrical connection layers, n-type silicon layers, p-type silicon layers, and/or backing layers. In other embodiments, solar laminate 102 may have more or fewer layers 118, including only one layer, or may have different layers 118, and/or may have different types of layers 118. The solar laminate 102 includes a plurality of solar cells (not shown), each of which converts solar energy to electrical energy. The outputs of the solar cells are connected in series and/or parallel to produce the desired output voltage and current for the solar laminate 102.

As shown in FIG. 1, the frame 104 circumscribes the solar laminate 102. The frame 104 is coupled to the solar laminate 102, as best seen in FIG. 2. The frame 104 assists in protecting the edges 110 of the solar laminate 102. In this embodiment, the frame 104 is constructed of four frame members 120. In other embodiments the frame 104 may include more or fewer frame members 120.

This frame 104 includes an outer surface 130 spaced apart from solar laminate 102 and an inner surface 132 adjacent solar laminate 102. The outer surface 130 is spaced apart from and substantially parallel to the inner surface 132. In this embodiment, the frame 104 is made of aluminum. More particularly, in some embodiments the frame 104 is made of 6000 series anodized aluminum. In other embodiments, the frame 104 may be made of any other suitable material providing sufficient rigidity including, for example, rolled or stamped stainless steel, plastic, or carbon fiber.

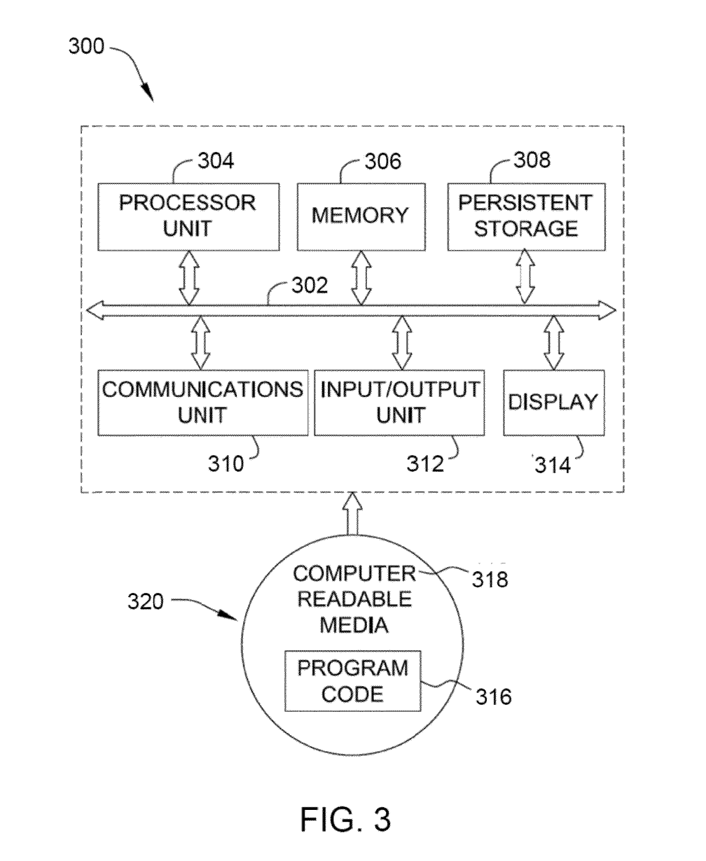

Some exemplary methods and systems are performed using and/or include computing devices. FIG. 3 is a block diagram of an exemplary computing device 300 that may be used. In the exemplary implementation, computing device 300 includes communications fabric 302 that provides communications between a processor unit 304, a memory 306, persistent storage 308, a communications unit 310, an input/output (I/O) unit 312, and a presentation interface, such as a display 314. In addition to, or in alternative to, the presentation interface may include an audio device (not shown) and/or any device capable of conveying information to a user. In some embodiments, computing device 300 is a simpler computing device 300 that does not include one or more of the components of computing device 300 described herein.

Processor unit 304 executes instructions for software that may be loaded into a storage device (e.g., memory 306). Processor unit 304 may be a set of one or more processors or may include multiple processor cores, depending on the particular implementation. Further, processor unit 304 may be implemented using one or more heterogeneous processor systems in which a main processor is present with secondary processors on a single chip. In another implementation, processor unit 304 may be a homogeneous processor system containing multiple processors of the same type. It should be understood that the terms “processor” and “processor unit” refer generally to any programmable system including systems and microcontrollers, reduced instruction set circuits (RISC), application specific integrated circuits (ΔSIC), programmable logic circuits, and any other circuit or processor capable of executing the functions described herein. The above examples are exemplary only, and thus are not intended to limit in any way the definition and/or meaning of the term “processor” or “processor unit.”

Memory 306 and persistent storage 308 are examples of storage devices. As used herein, a storage device is any tangible piece of hardware that is capable of storing information either on a temporary basis and/or a permanent basis. Memory 306 may be, for example, without limitation, random access memory (RAM) such as dynamic RAM (DRAM) or static RAM (SRAM), read-only memory (ROM), erasable programmable read-only memory (EPROM), electrically erasable programmable read-only memory (EEPROM), non-volatile RAM (NVRAM), and/or any other suitable volatile or non-volatile storage device. Persistent storage 308 may take various forms depending on the particular implementation, and persistent storage 308 may contain one or more components or devices. For example, persistent storage 308 may be one or more hard drives, flash memory, rewritable optical disks, rewritable magnetic tapes, and/or some combination of the above. The media used by persistent storage 308 also may be removable. For example, without limitation, a removable hard drive may be used for persistent storage 308.

A storage device, such as memory 306 and/or persistent storage 308, may be configured to store data for use with the processes described herein. For example, a storage device may store (e.g., have embodied thereon) computer-executable instructions, executable software components, PV system component data, PV system layouts, installation instructions, work orders, and/or any other information suitable for use with the methods described herein. When executed by a processor (e.g., processor unit 304), such computer-executable instructions and/or components cause the processor to perform one or more of the operations described herein.

Communications unit 310, in these examples, provides for communications with other computing devices or systems. In the exemplary implementation, communications unit 310 is a network interface card. Communications unit 310 may provide communications through the use of either or both physical and wireless communication links. Communication unit 310 provides communication to one or more element of the PV system.

Input/output unit 312 enables input and output of data with other devices that may be connected to computing device 300. For example, without limitation, input/output unit 312 may provide a connection for user input through a user input device, such as a keyboard and/or a mouse. Further, input/output unit 312 may send output to a printer. Display 314 provides a mechanism to display information, such as any information described herein, to a user. For example, a presentation interface such as display 314 may display a graphical user interface, such as those described herein. The communication device 310 may include one or more analog I/O.

Instructions for the operating system and applications or programs are located on persistent storage 308. These instructions may be loaded into memory 306 for execution by processor unit 304. The processes of the different implementations may be performed by processor unit 304 using computer implemented instructions and/or computer-executable instructions, which may be located in a memory, such as memory 306. These instructions are referred to herein as program code (e.g., object code and/or source code) that may be read and executed by a processor in processor unit 304. The program code in the different implementations may be embodied in a non-transitory form on different physical or tangible computer-readable media, such as memory 306 or persistent storage 308.

Program code 316 is located in a functional form on non-transitory computer-readable media 318 that is selectively removable and may be loaded onto or transferred to computing device 300 for execution by processor unit 304. Program code 316 and computer-readable media 318 form computer program product 320 in these examples. In one example, computer-readable media 318 may be in a tangible form, such as, for example, an optical or magnetic disc that is inserted or placed into a drive or other device that is part of persistent storage 308 for transfer onto a storage device, such as a hard drive that is part of persistent storage 308. In a tangible form, computer-readable media 318 also may take the form of a persistent storage, such as a hard drive, a thumb drive, or a flash memory that is connected to computing device 300. The tangible form of computer-readable media 318 is also referred to as computer recordable storage media. In some instances, computer-readable media 318 may not be removable.

Alternatively, program code 316 may be transferred to computing device 300 from computer-readable media 318 through a communications link to communications unit 310 and/or through a connection to input/output unit 312. The communications link and/or the connection may be physical or wireless in the illustrative examples. The computer-readable media also may take the form of non-tangible media, such as communications links or wireless transmissions containing the program code.

In some illustrative implementations, program code 316 may be downloaded over a network to persistent storage 308 from another computing device or computer system for use within computing device 300. For instance, program code stored in a computer-readable storage medium in a server computing device may be downloaded over a network from the server to computing device 300. The computing device providing program code 316 may be a server computer, a workstation, a client computer, or some other device capable of storing and transmitting program code 316.

Program code 316 may be organized into computer-executable components that are functionally related. Each component may include computer-executable instructions that, when executed by processor unit 304, cause processor unit 304 to perform one or more of the operations described herein.

The different components illustrated herein for computing device 300 are not meant to provide architectural limitations to the manner in which different implementations may be implemented. The different illustrative implementations may be implemented in a computer system including components in addition to or in place of those illustrated for computing device 300. For example, in some embodiments, computing device includes a global positioning system (GPS) receiver. Moreover, components shown in FIG. 3 can be varied from the illustrative examples shown and more or fewer components may be included. As one example, a storage device in computing device 300 is any hardware apparatus that may store data. Memory 306, persistent storage 308 and computer-readable media 318 are examples of storage devices in a tangible form.

In another example, a bus system may be used to implement communications fabric 302 and may include one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, without limitation, memory 306 or a cache such as that found in an interface and memory controller hub that may be present in communications fabric 302.

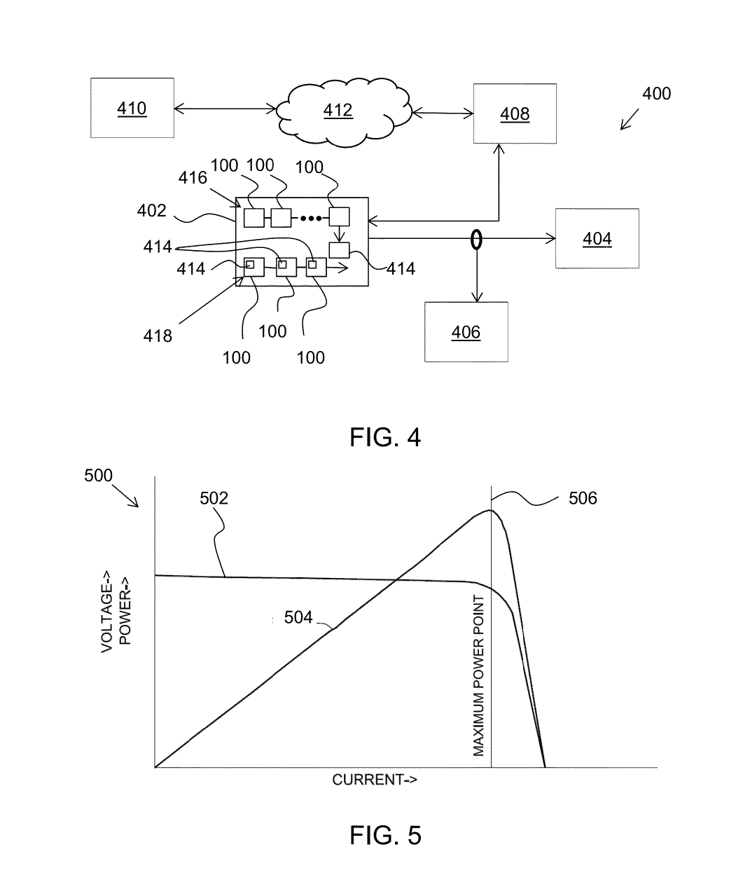

FIG. 4 is a block diagram of an exemplary PV system 400. The PV system 400 includes an array 402 of PV modules 100 and one or more inverters. The array 402 outputs AC power to one or more loads 404. In the exemplary embodiment, system 400 is a grid-tied system and load 404 is an electric distribution grid. Alternatively, loads 404 may be any other suitable loads. A meter 406 measures the power delivered to the loads 404. A gateway device 408, also referred to as a data acquisition device, a data logger, or a data acquisition system (DAS), monitors the array 402 and transmits data collected from the array 402 to a backend system 410 via a network 412. Backend system 410 includes one or more computing devices 300. Backend system 410 is usually located at a second location physically separated from the first location at which PV system 400 is located. Alternatively, the second system may be located at the same site as the PV system 400. Moreover, the gateway device 408 may provide information to and communicate with more than one backend systems 410. The distance between the first location and the second location will vary among installed PV systems 400. In some embodiments, the first location and the second location are greater than five miles apart. In other embodiments, the first and second locations are more than ten miles apart, 25 miles apart, 50 miles apart, 100 miles apart, 200 miles apart, or even located on different continents.

The array 402 may be any suitable array of PV modules 100 and one or more inverters 414. For example, the array 402 may include a plurality of PV modules arranged in a string 416 of PV modules 100. Each string of modules is connected to a single inverter 414 to convert the DC output of the string of PV modules to an AC output. Alternatively, or additionally, each PV module 100 in a string 418 may be coupled to its own inverter 414 (sometimes referred to as a microinverter) positioned near or on the PV module to which it is electrically coupled. In still other examples, a plurality of strings of PV modules may be connected, directly or through one or more string combiners, to a single inverter 414, sometimes referred to as a central or string inverter. In addition to converting the DC output of modules 100 to an AC output, inverters 414 perform, for example, MPPT for one or more PV module 100.

In embodiments that do not include microinverters, the array 402 may include a direct current power manager (DCPM) coupled to each PV module. The DCPM performs, for example, maximum power point tracking (MPPT) for the PV module. It may also selectively control (i.e., limit and/or increase) the maximum power output of the PV module and/or control the conduction of bypass diodes based on temperature and bypass current. The DCPM may also translates the output I-V curve of the PV module to a new I-V curve at which the output voltage does not vary with ambient temperature.

In some embodiments, the array 402 includes one or more tracking devices configured to selectively position the PV modules relative to the sun to attempt to maximize the solar energy incident on the PV modules over time. Any other suitable arrangement of PV modules and inverter(s) may be used, including combinations of the arrangements described above.

The gateway device 408 collects data concerning array 402, such as via one or more sensors (not shown). The gateway device 408 is and/or includes a computing device, such as computing device 300. The collected data may include any appropriate operational, situational, environmental, or other data related to the operation and/or condition of the array 402. For example, the gateway may monitor the ambient air temperature around the array 402, the amount of sunlight incident on the array 402 (or one or more PV module), the output voltage and current of the array 402, the output voltage and current of each PV module, the output voltage and current of each inverter and/or microinverter 414, the surface temperature of the PV modules 100, etc. Moreover, in some embodiments, the gateway device 408 is in communication with one or more components of the array 402. For example, the gateway device 408 may be in communication with one or more inverters 414 in the array 402. Each inverter 414 may provide the gateway device 408 with, for example, its input voltage, its input current, its output voltage, its output current, etc. In some embodiments, the array 402 (and more particularly the inverters 414) may be controlled via the gateway device 408.

In one example, the network 412 is the Internet. In other implementations, network 412 is any other suitable communication network, including, for example, a wide area network (WAN), a local area network (LAN), a cellular network, etc. Network 412 may include more than one network. For example, gateway device 408 may connect to the Internet through one or more other networks and/or interfaces, such as a local area network (LAN), a wide area network (WAN), a home area network (HAN), dial-in-connections, cable modems, and high-speed ISDN lines.

FIG. 5 is an example graph 500 of voltage 502 and power 504 output of a PV module (such as PV modules 100) as a function of output current of the PV module. The maximum power point (MPP) 506 of the PV module is the output current that will produces the maximum power output of the PV module under the present conditions. The graph 500 and the location/value of the MPP 506 generally change as operating conditions (temperature, irradiance, etc.) change.

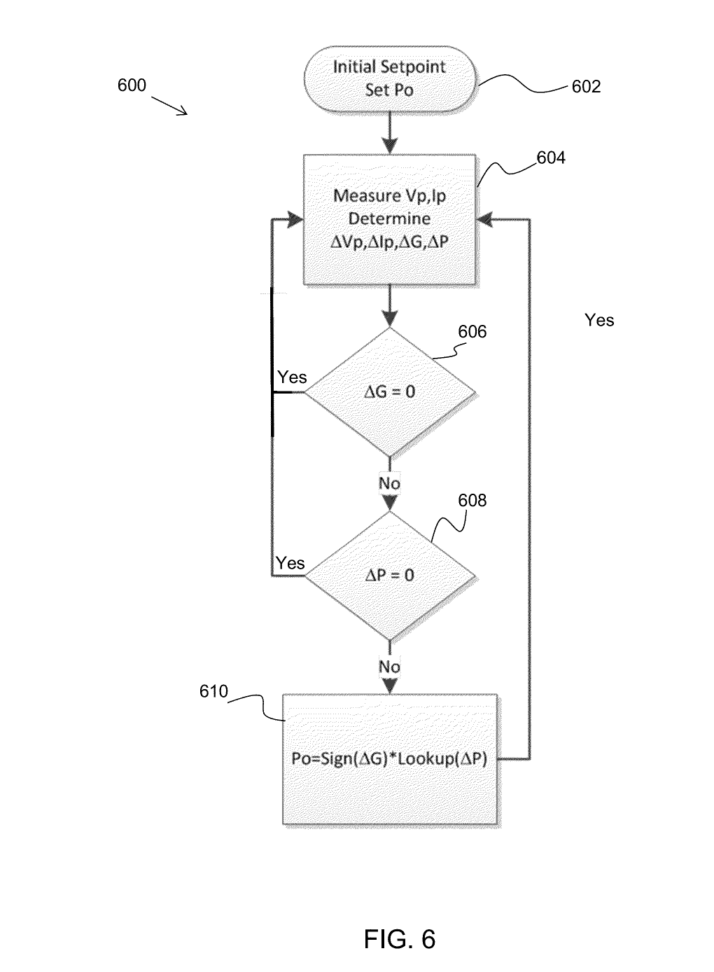

FIG. 6 is flow diagram of an exemplary method 600 for operating a PV system. The method 600 will be described with reference to PV system 400 and the components of PV system 400, but the method 600 may be used in connection with any suitable PV system. For simplicity of explanation, the method 600 will be described with reference to a single PV module 100, although method 600 may be applied to more than one module 100, strings 416 and 418, arrays 402, and the like. Method 600 is performed by one or more computing device 300. More specifically, method 600 is generally performed by a computing device 300 and/or a processor included within inverters 414 (whether string inverters, central inverters, microinverters, or the like), DCPMs, and/or any other control systems coupled to one or more PV modules 100.

Method 600 is a method for controlling operating of a PV system, such as PV system 400, to operate at substantially the MPP of the module 100 based on the trans-conductance of the module 100.

At 602, an initial setpoint is set for the power output (Po). An inverter 414 and PV module 100 is rated for a given output power. When the inverter 414 is started, the power output set point Po is set at a determined or predetermined output power level. The initial setpoint may be, for example, the rated power output of the PV module 100 or a power output less than the rated power output of the PV module 100. In one example embodiment, the initial setpoint power output Po is about 50% of the rated power output of the PV module 100. In other embodiments, the initial setpoint power output is set below at a point below the available power (based on the input voltage and current). In one embodiment, the initial setpoint power output is set at −10% of available power. In still other embodiments, the initial setpoint power output is determined as a function of the available, rated, or maximum output power, as a function of one or more inputs to the inverter 414, or as a function of any other suitable variables.

The inverter is initially operated with the initial setpoint power output Po. For a predetermined number of AC cycles, the setpoint power level is varied at line frequency (i.e., the frequency of the load 404) by a small fraction of the maximum power of the PV module. In an example embodiment, the predetermined number of cycles is 20 cycles. After the predetermined number of cycles, the output power setpoint is only varied as described below. Alternatively, the predetermined number of cycles may be more or fewer cycles. After the predetermined number of cycles, the output power setpoint is only varied as described below. In one example, the setpoint power level is varied by an amount equal to about 10% of the maximum power of the PV module 100. Alternatively, any other suitable setpoint variation may be used. After the predetermined number of cycles, the output power setpoint is only varied as described below.

At 604, the voltage and current input to the inverter 414 (and output from the PV module) are sampled by inverter 414. The panel voltage (Vp) and current (Ip) are sampled at a high frequency relative to an AC line frequency of 50-60 Hz. The changes in voltage (ΔVp), current (ΔIp), and power (ΔP) as the power setpoint Po is changed are calculated and used to determine the trans-conductance (G) of the PV module 100 and the change in trans-conductance (ΔG). The change in current ΔIp and change in voltage ΔVp between a cycle and the previous cycle are calculated using:

ΔIp=Ip−Ip (previous Cycle) (1)

ΔVp=Vp−Vp (previous Cycle) (2)

The change in power AP is calculated using the results from equations (1) and (2) in:

ΔP=VpΔIp+IpΔVp (3)

The trans-conductance G of the PV module 100 is calculated as:

$$G = \frac{Ip}{Vp} \qquad ( 4 )$$

, and the change in trans-conductance is:

$$Δ G = ( \frac{Ip}{Vp} - \frac{Ip ( Previous )}{Vp ( Previous )} ) \qquad ( 5 )$$

Equations (4) and (5) are subject to the condition that Vp does not equal zero. At the MPP, ΔG and ΔP equal zero.

At 606, the change in trans-conductance ΔG is compared to zero. If the change in trans-conductance ΔG is zero, the trans-conductance G did not change over the last cycle and method 600 returns to 604. If ΔG does not equal zero, method 600 continues to 608. At 608, the change in power ΔP from equation (3) is compared to zero. If ΔP equals zero, the power did not change over the last cycle and method 600 returns to 604. If ΔP does not equal zero, the method 600 continues to 610.

At 610, which is reached when ΔG and ΔP do not equal zero, the power setpoint Po is determined by

Po=sign (ΔG)*Lookup (ΔP) (6)

From equation (6), the sign of ΔG (from equation (5)) determines the output power set point Po direction (i.e., whether to increment or decrement the output power level). The value of ΔP (from equation (3)) determines how much the output power set point Po is incremented or decremented (i.e., the amount of the perturb). The amount by which to change the setpoint Po is determined from a lookup table. In the example embodiment, the amount by which the output power setpoint is varied in the lookup table is determined using a weighted average output, which is a binomial series approximation of the rated output power (i.e. 50%, 20%, 10%, 5%, 2%, 1%, 0.5%, 0.1%, etc). The output power level of the inverter 414 is set at zero cross of each phase of the inverter for smooth transition towards converging MPPT of the solar panel. In other embodiments, the lookup table may be determined using any other suitable basis for determining a perturb amount as a function of the amount of change od output power ΔP. Alternatively, the amount by which to perturb the setpoint Po may be calculated (rather than being determined from a lookup table), or determined by any other suitable method. After the output power setpoint Po is set in 610, the method 600 returns to 604.

MPOTCT acronym for Modified Perturb Observe of Trans-Conductance Transfer is an algorithm which extracts maximum power from the Solar panel or Array irrespective panel or Array size and characteristics (making the same algorithm to work on a narrow as well as wide band of input voltages). The algorithm makes use of Trans-Conductance parameter of the solar panel which varies with incident sunlight making it more effective to extract energy from the solar panel. The algorithm tracks the Trans-Conductance of the solar panel which is much faster than conventional MPPT tracking methods.

A technical effect of the method, device, and system described herein may include one or more of: (a) determining a change in a voltage output of the PV module from a first time to a second time; (b) determining a change in a current output of the PV module from the first time to the second time; (c) determining a change in a power output of the PV module based, at least in part, on the determined change in current output and change in voltage output; (d) determining a change in a trans-conductance of the PV module from the first time to the second time; and (e) setting a power output setpoint for the inverter as a function of the determined change in trans-conductance and the determined change in power output

The methods and systems of the present disclosure provide maximum power point tracking for a PV system. The maximum power point is tracked based on the trans-conductance of the PV module(s). The maximum power point is detected in a short span of time without oscillations. The system may converge to the maximum power point in a few AC line Cycles. The change and the direction of change of the power output setpoint are always known based on the trans-conductance of the PV module(s). Exemplary embodiments extract maximum power from the PV module(s) irrespective of module, string, or array size and characteristics. Thus, exemplary embodiments work on a narrow as well as wide band of input voltages. The exemplary embodiments make use of the trans-conductance parameter of PV modules, which varies with incident sunlight, making them more effective and faster than other known MPPT tracking methods.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A method of operating a photovoltaic (PV) system substantially at a maximum power point, the PV system including a PV module and an inverter coupled to the PV module, the method comprising:
determining, by the inverter, a change in a voltage output of the PV module from a first time to a second time;
determining, by the inverter, a change in a current output of the PV module from the first time to the second time;
determining, by the inverter, a change in a power output of the PV module based, at least in part, on the determined change in current output and change in voltage output;
determining, by the inverter, a change in a trans-conductance of the PV module from the first time to the second time; and
setting, by the inverter, a power output setpoint for the inverter as a function of the determined change in trans-conductance and the determined change in power output.

2. The method of claim 1, further comprising detecting, by the inverter, the voltage output of the PV module at the first time and the second time.

3. The method of claim 1, further comprising detecting, by the inverter, the current output of the PV module at the first time and the second time.

4. The method of claim 1, wherein setting the power output setpoint for the inverter as a function of the determined change in trans-conductance and the determined change in power output comprises determining whether to increase or decrease the power output setpoint based on a sign of the determined change in trans-conductance.

5. The method of claim 4, wherein setting the power output setpoint for the inverter as a function of the determined change in trans-conductance and the determined change in power output comprises determining a a magnitude of a change to the power output setpoint as a function of the determined change in power output.

6. The method of claim 1, further comprising setting an initial power output setpoint as a function of an output power rating of one of the PV module and the inverter.

7. The method of claim 6, further comprising varying the initial power output setpoint by a predetermined amount to determine an initial trans-conductance of the PV module.

8. A method of operating a photovoltaic (PV) system substantially at a maximum power point, the PV system including a PV module and an inverter coupled to the PV module, the method comprising:
controlling an output of the inverter as a function of a trans-conductance of the PV module over time.

9. The method of claim 8, wherein controlling the output of the inverter as a function of a trans-conductance of the PV module comprises varying a power output setpoint of the inverter as a function of the trans-conductance of the PV module.

10. The method of claim 9, further comprising calculating a change in the trans-conductance of the PV module as a function of at least two measurements of an output current and an output voltage of the PV module.

11. The method of claim 9, wherein controlling the output of the inverter as a function of a trans-conductance of the PV module comprises varying a power output setpoint of the inverter to achieve a value of zero for a calculated change in the trans-conductance of the PV module.

12. The method of claim 9, wherein varying a power output setpoint of the inverter as a function of the trans-conductance of the PV module comprises varying a power output setpoint of the inverter as a function of a change in the trans-conductance of the PV module and a change in a power output of the PV module over a period of time.

13. A computing device for use in a photovoltaic (PV) system including a PV module and an inverter, said computing device comprising a processor and a memory coupled to the processor, wherein the memory comprises computer-executable instructions that, when executed by the processor, cause the computing device to:
determine a change in a voltage output of the PV module from a first time to a second time;
determine a change in a current output of the PV module from the first time to the second time;
determine a change in a power output of the PV module based, at least in part, on the determined change in current output and change in voltage output;
determine a change in a trans-conductance of the PV module from the first time to the second time; and
set a power output setpoint for the inverter as a function of the determined change in trans-conductance and the determined change in power output.

14. The computing device of claim 13, wherein the memory further comprises computer-executable instructions that, when executed by the processor, cause the computing device to detect the voltage output of the PV module at the first time and the second time.

15. The computing device of claim 13, wherein the memory further comprises computer-executable instructions that, when executed by the processor, cause the computing device to detect the current output of the PV module at the first time and the second time.

15. The computing device of claim 13, wherein the memory further comprises computer-executable instructions that, when executed by the processor, cause the computing device to determine whether to increase or decrease the power output setpoint based on a sign of the determined change in trans-conductance.

16. The computing device of claim 15, wherein the memory further comprises computer-executable instructions that, when executed by the processor, cause the computing device to determine a magnitude of a change to the power output setpoint as a function of the determined change in power output.

17. The computing device of claim 13, wherein the memory further comprises computer-executable instructions that, when executed by the processor, cause the computing device to set an initial power output setpoint as a function of an output power rating of one of the PV module and the inverter.

18. The computing device of claim 17, wherein the memory further comprises computer-executable instructions that, when executed by the processor, cause the computing device to vary the initial power output setpoint by a predetermined amount to determine an initial trans-conductance of the PV module.

19. The computing device of claim 13, wherein the computing device is a component of the inverter.
